(19) United States
(12) Patent Application Publication
(10) Pub. No.: US 2026/0067013 A1
(43) Pub. Date: Mar. 5, 2026

(54) USER EQUIPMENT FOR PERFORMING WIRELESS COMMUNICATION WITH BASE STATION AND OPERATION METHOD OF USER EQUIPMENT

(71) Applicant: Samsung Electronics Co., Ltd., Suwon-si (KR)

(72) Inventors: Yejin LEE, Suwon-si (KR); Jungho SO, Suwon-si (KR)

(73) Assignee: Samsung Electronics Co., Ltd., Suwon-si (KR)

(21) Appl. No.: 19/222,591

(22) Filed: May 29, 2025

(30) Foreign Application Priority Data
Sep. 3, 2024 (KR) 10-2024-0119561

(51) Int. Cl. H04B 17/364; H04B 1/7113; H04B 17/309; H04L 5/00

(52) U.S. Cl. CPC H04B 17/364; H04B 1/7113; H04B 17/346; H04L 5/0051

(57) ABSTRACT

An operation method of user equipment configured to perform wireless communication with a base station includes receiving a positioning reference signal (PRS) from the base station, calculating a power delay profile (PDP) based on the PRS, detecting at least one path by performing a path search operation based on the PDP, the at least one path including a first path, the path search operation including detecting a first PDP index as the first path, the first PDP index having a value corresponding to a first power of a first threshold PDP or more, and the first threshold PDP being based on a peak power of the PDP, and measuring a reference signal time difference (RSTD) based on the first path.

### CROSS-REFERENCE TO RELATED APPLICATION

This application is based on and claims priority under 35 U.S.C. § 119 to Korean Patent Application No. 10-2024-0119561, filed on Sep. 3, 2024, in the Korean Intellectual Property Office, the disclosure of which is incorporated by reference herein in its entirety.

### BACKGROUND

The inventive concepts relate to wireless communication, and more particularly, to a user equipment (UE) configured to perform an operation of estimating a position of a first arrival path (FAP) based on a positioning reference signal (PRS) and an operation method of the user equipment.

To estimate positions of UEs, there are many positioning techniques that are standardized, and many such techniques may include Downlink-Time Difference of Arrival (DL-TDoA) that is a technique based on time, Downlink-Angle of Departure (DL-AoD) that is a technique based on angles, and the like.

In particular, in DL-TDoA, a user equipment may measure a reference signal time difference (RSTD), which is a difference between times at which downlink-positioning reference signals (DL-PRSs) transmitted by base stations of different cells adjacent to each other have arrived at the user equipment, and may report the RSTD to a base station, and the base station may estimate the position of the user equipment based on the RSTD.

### SUMMARY

The inventive concepts provide a user equipment configured to perform an operation of estimating a position of a first arrival path (FAP) based on a positioning reference signal (PRS) and an operation method of the user equipment. Embodiments provide a technique for estimating accurate positions of FAPs of PRSs to estimate accurate positions of UEs.

According to an aspect of the inventive concepts, there is provided an operation method of a user equipment configured to perform wireless communication with a base station, the operation method including receiving a positioning reference signal (PRS) from the base station, calculating a power delay profile (PDP) based on the PRS, detecting at least one path by performing a path search operation based on the PDP, the at least one path including a first path, the path search operation including detecting a first PDP index as the first path, the first PDP index having a value corresponding to a first power of a first threshold PDP or more, and the first threshold PDP being based on a peak power of the PDP, and measuring a reference signal time difference (RSTD) based on the first path.

According to an aspect of the inventive concepts, there is provided an operation method of a user equipment configured to perform wireless communication with a base station, the operation method including receiving a positioning reference signal (PRS) from the base station, calculating a corrected power delay profile (PDP) by removing noise based on the PRS, detecting a first PDP index as a first path among at least one path, the first PDP index having a value corresponding to a first power of a first threshold PDP or more, the first threshold PDP being a product of peak power of the PDP and a first ratio, and the first ratio being a real number of 1 or less, generating at least one adjusted path by performing a fine-tuning operation based on the at least one path, and measuring a reference signal time difference (RSTD) based on the at least one adjusted path.

According to an aspect of the inventive concepts, there is provided a user equipment configured to perform wireless communication with a base station, the user equipment including a plurality of antennas, and processing circuitry configured to receive a positioning reference signal (PRS) from the base station, calculate a power delay profile (PDP) based on the PRS, detect at least one path by performing a path search operation based on the PDP, the at least one path including a first path, the path search operation including detecting a first PDP index as the first path, the first PDP index having a value corresponding to a first power of a first threshold PDP or more, and the first threshold PDP being based on a peak power of the PDP, and measure a reference signal time difference (RSTD) based on the first path.

### BRIEF DESCRIPTION OF THE DRAWINGS

Brief descriptions of respective drawings are provided to gain a sufficient understanding of the drawings of the detailed description of the inventive concepts.

Embodiments will be more clearly understood from the following detailed description taken in conjunction with the accompanying drawings in which:

FIG. 1 is a block diagram illustrating a wireless communication system according to embodiments;

FIG. 2 is a flowchart illustrating an operation method of a user equipment, according to embodiments;

FIG. 3 is a flowchart illustrating a denoising operation of a user equipment, according to embodiments;

FIG. 4 is a graph illustrating a denoising operation of a user equipment, according to embodiments;

FIG. 5 is a graph illustrating a path search operation of a user equipment, according to embodiments;

FIG. 6 is a graph illustrating a path search operation of a user equipment, according to embodiments;

FIG. 7 is a flowchart illustrating an operation method of a user equipment, according to embodiments;

FIG. 8 is a graph illustrating an operation of a user equipment, according to embodiments;

FIG. 9 is a block diagram illustrating a user equipment according to embodiments;

FIG. 10 is a block diagram illustrating an electronic device according to embodiments; and

FIG. 11 is a conceptual diagram illustrating an Internet-of-Things (IoT) network system to which embodiments are applied.

### DETAILED DESCRIPTION

Hereinafter, although embodiments are described in accordance with new radio (NR) network-based wireless communication systems, particularly, 3GPP, the inventive concepts are not limited to NR networks and may be applied to any other wireless communication systems (for example, cellular communication systems, such as long-term evolution (LTE) systems, LTE-advanced (LTE-A) systems, wireless broadband (WiBro) systems, global system for mobile communication (GSM) systems, or next-generation (for example, 6G or the like) communication systems) or short-range communication systems, such as Bluetooth systems and near-field communication (NFC) systems), which have technical backgrounds or channel setting similar to NR systems.

In addition, various functions described below may be implemented or supported by artificial intelligence technology or by one or more computer programs, and each of the programs includes computer-readable program code and is implemented on a non-transitory computer-readable medium. The terms “application” and “program” refer to one or more computer programs, software components, instruction sets, procedures, functions, objects, classes, instances, related data, or portions thereof suitable for the implementation of suitable computer-readable program code. The term “computer-readable program code” includes any types of computer code including source code, object code, and execution code. The term “computer-readable medium” includes any types of media, such as read-only memory (ROM), random access memory (RAM), hard disk drives, compact discs (CDs), digital video disks (DVDs), or any other types of memory, which may be accessed by computers. A “non-transitory” computer-readable medium does not include wired, wireless, optical, or other communication links for transmitting temporary electrical or other signals. The non-transitory computer-readable medium includes a medium in which data may be permanently stored, and media in which data may be stored and overwritten afterward, such as rewritable optical disks or erasable memory devices.

In embodiments described below, a hardware approach is described as an example. However, because embodiments of the inventive concepts include a technique using both hardware and software, embodiments do not exclude software-based approaches.

Hereinafter, embodiments will be described in detail with reference to the accompanying drawings.

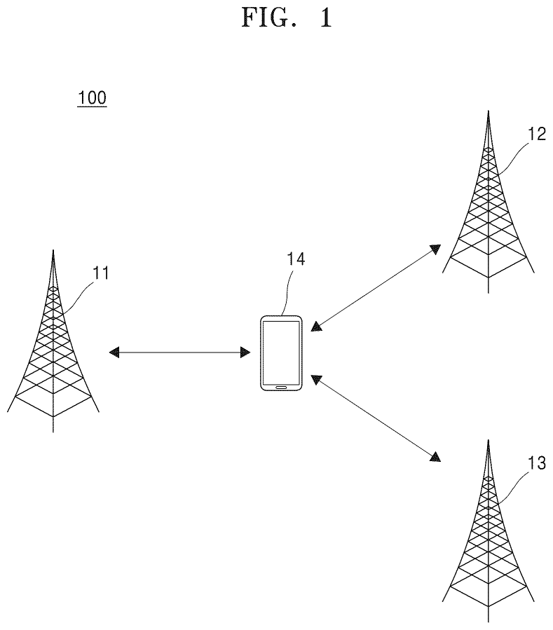

FIG. 1 is a block diagram illustrating a wireless communication system according to embodiments.

Referring to FIG. 1, a wireless communication system 100 may include base stations 11, 12, and/or 13 and/or a user equipment 14. Each of the base stations 11, 12, and 13 may generally refer to a fixed station communicating with the user equipment 14 and other base stations (not shown), or may refer to a satellite (for example, one of a geostationary orbit (GEO) satellite and a low-earth orbit (LEO) satellite) that is mobile and communicates with the user equipment 14 and other base stations (not shown). For example, the base station 11 may support a non-terrestrial network and/or a terrestrial network.

The base stations 11, 12, and 13 may exchange data and control information with the user equipment 14 and other base stations (not shown) by communicating with the user equipment 14 and the other base stations (not shown). For example, each of the base stations 11, 12, and 13 may be referred to as a transmission and reception point (TRP), a cell, a NodeB, an evolved-Node B (eNB), a next-generation Node B (gNB), a sector, a site, a base transceiver system (BTS), an access point (AP), a relay node, a remote radio head (RRH), a radio unit (RU), a small cell, a device, or the like. Each of the base stations 11, 12, and 13 may provide wireless broadband access to the user equipment 14 within the coverage thereof.

The user equipment 14 may refer to any equipment that is stationary or mobile and may transmit data or control information to and receive data or control information from the base stations 11, 12, and 13 by communicating with the base stations 11, 12, and 13. For example, the user equipment 14 may be referred to as a terminal, a terminal equipment, a mobile station (MS), a mobile terminal (MT), a user terminal (UT), a subscribe station (SS), a wireless communication device, a wireless device, a handheld device, or the like. Although only the user equipment 14 is illustrated herein, the inventive concepts are not limited thereto. For example, the wireless communication system 100 may further include other UEs (not shown) in addition to the user equipment 14.

The wireless communication system 100 may perform a positioning operation that is an operation of estimating the position of the user equipment 14. In embodiments, the wireless communication system 100 may perform a positioning operation by using a downlink-time difference of arrival (DL-TDoA) technique. The user equipment 14 may receive downlink-power reference signals (DL-PRSs) respectively transmitted by base stations (for example, 11, 12, and 13) of different cells adjacent to each other and may measure a reference signal time difference (RSTD), which refers to a difference in arrival time between the PRSs, based on the received DL-PRSs. A PRS may refer to a reference signal used to estimate the position of a user equipment, and the user equipment 14 may receive a PRS via a resource block of a downlink subframe determined (or otherwise, configured) for PRS transmission. The user equipment 14 may transmit the RSTD to a location management function (LMF) (for example, the base station 11), which refers to a server for estimating the position of the user equipment 14 within the wireless communication system 100, and the LMF (for example, the base station 11) may estimate the position of the user equipment 14 based on the RSTD.

The user equipment 14 may receive the PRS via a multipath having several paths for receiving signals, due to scattering, diffraction, reflection, or the like of electromagnetic waves. The multipath may include a line-of-sight (LoS) path, and a non-light-of-sight (NLoS) path due to scattering, diffraction, or reflection. The user equipment 14 may measure a relatively accurate RSTD in the case of measuring the RSTD based on a PRS received via an LoS path, as compared with the case of measuring the RSTD based on a PRS received via an NLoS path. The LoS path may be referred to as a first arrival path (FAP), and the user equipment 14 needs to (or otherwise, may) detect an FAP of the received PRS to measure a relatively accurate RSTD.

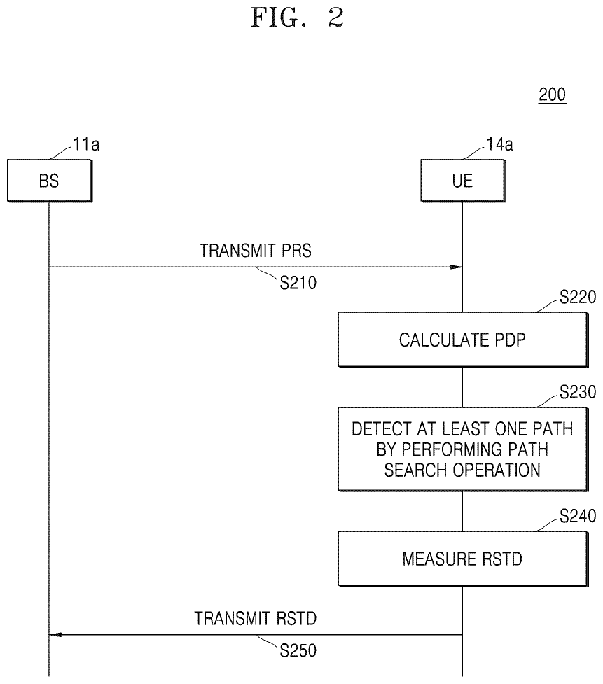

To measure a relatively accurate RSTD, the wireless communication system 100 according to the inventive concepts may calculate a power delay profile (PDP) based on a PRS and may detect, as an FAP, a PDP index having a value of a first threshold PDP or more in the PDP by performing a path search operation based on the calculated PDP. Because the path search operation is performed for each PDP index, a relatively accurate FAP may be detected, and thus, a relatively accurate RSTD may be measured, thereby estimating the accurate position of the user equipment 14. Specific examples of the positioning operation are described below with reference to FIGS. 2 to 11.

FIG. 2 is a flowchart illustrating an operation method of a user equipment, according to embodiments.

Referring to FIG. 2, an operation method 200 of a user equipment 14a may include a plurality of operations S210 to S250, and a base station 11a and the user equipment 14a may be examples of the base station 11 and the user equipment 14 of FIG. 1, respectively. Repeated descriptions given with reference to FIG. 1 are omitted.

In operation S210, the user equipment 14a may receive a PRS from the base station 11a. In embodiments, the user equipment 14a may receive PRSs from the base station 11a and other base stations (for example, 12 and 13 of FIG. 1) that are adjacent to the base station 11a.

In operation S220, the user equipment 14a may calculate a PDP. The PDP, which is a function of time delay, may refer to a graph representing signal strength (or power) and/or may refer to a graph illustrating signal strength (or power) versus time delay for a reception signal received via a multipath.

In embodiments, the user equipment 14a may calculate the PDP based on the PRSs received from the base station 11a and the other base stations (for example, 12 and 13 of FIG. 1) adjacent to the base station 11a. For example, the user equipment 14a may calculate a channel impulse response (CIR) based on the received PRSs and may calculate the PDP based on the calculated CIR. For example, the user equipment 14a may respectively merge the PRSs into a plurality of symbols based on patterns of the received PRSs, and then, may calculate each of the symbols as a PDP.

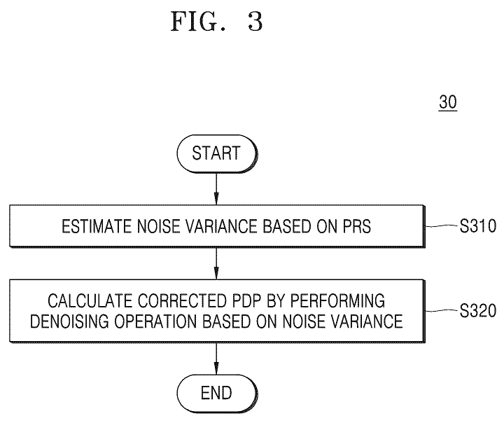

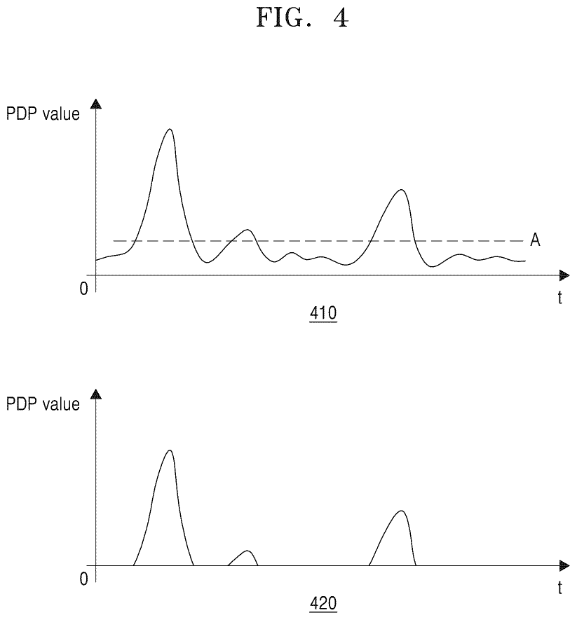

In embodiments, the user equipment 14a may calculate a PDP based on a PRS and may calculate a corrected PDP by performing a denoising operation on the calculated PDP, the denoising operation being an operation of removing noise. Specific examples related to the denoising operation are described below with reference to FIGS. 3 and 4.

In operation S230, the user equipment 14a may detect at least one path by performing a path search operation. The at least one path may include an FAP that refers to an LoS path.

In embodiments, the user equipment 14a may detect at least one path including a first path by performing a path search operation based on the PDP, and the path search operation may include an operation of detecting, as the first path, a PDP index having a value of a first threshold PDP or more in the PDP. The first path may refer to an FAP, and the PDP index may refer to an index corresponding to a time delay in the PDP. The time delay is a timing offset and may refer to a sampled time delay. Each of the PDP indices may have a value of power (or signal strength) calculated based on the PRS, and the highest value of power among the values of power of the PDP indices may be referred to as peak power of the PDP. The first threshold PDP may be set based on the peak power of the PDP.

For example, the PDP calculated in operation S220 may include a plurality of PDP indices, and the first threshold PDP may be set as a product of the peak power of the PDP and a first ratio. The first ratio may be a real number of 0 to 1. The user equipment 14a may detect, as the first path, a PDP index having a value of the first threshold PDP or more in the PDP. When there are a plurality of PDP indices having values of the first threshold PDP or more, the user equipment 14a may detect, as the first path, a PDP index having the smallest index value (or a PDP index having the smallest time delay).

In embodiments, the user equipment 14a may detect a multipath including at least one path by performing a path search operation based on the PDP, and the path search operation may include an operation of detecting the multipath including the first path, based on a plurality of threshold PDPs. For example, the user equipment 14a may select one of the plurality of threshold PDPs based on a channel state. When the first threshold PDP is selected from the plurality of threshold PDPs, the path search operation may include an operation of detecting, as the multipath, PDP indices having values of the first threshold PDP or more in the PDP, and the user equipment 14a may detect, as the first path, a PDP index having the smallest index value in the PDP indices detected as the multipath. For example, the plurality of threshold PDPs may include the first threshold PDP and a second threshold PDP, and the path search operation may include an operation of detecting PDP indices, which have values of the first threshold PDP or more in the PDP, as a multipath and detecting PDP indices, which have values of a second threshold PDP or more in the PDP, as a multipath. The user equipment 14a may designate, as a first candidate for the first path, a PDP index having the smallest index value among the PDP indices detected as the multipath, and may designate, as a second candidate for the first path, a PDP index having the smallest index value among the PDP indices detected as the multipath. The user equipment 14a may detect, as the first path, one of (e.g., only one among) the first candidate for the first path and the second candidate for the first path, based on the magnitude of power of the PDP index, the detected frequency of the PDP index, or the like. A specific example, in which the user equipment 14a detects at least one path including a multipath, is described below with reference to FIG. 6. According to embodiments, the first threshold PDP discussed above with respect to other examples of operation S230 may correspond to either among the first threshold PDP or the second threshold PDP discussed in this paragraph. As such the first threshold PDP and the second threshold PDP may also be referred to herein as the second threshold PDP and the third threshold PDP, respectively.

In embodiments, the user equipment 14a may perform the path search operation in ascending order of PDP indices of the PDP, starting from the smallest PDP index. For example, the user equipment 14a may compare the first threshold PDP with the PDP indices, starting from the smallest PDP index, and may detect, as the first path, a PDP index having a value of the first threshold PDP or more.

In operation S240, the user equipment 14a may measure a RSTD based on the at least one path that is detected. For example, the user equipment 14a may detect at least one path including an FAP, based on the PRSs received from the base station 11a and other base stations (for example, 12 and 13 of FIG. 1) adjacent to the base station 11a, and may measure an RSTD, which refers to a difference in arrival time between the PRSs, based on the at least one path.

In operation S250, the user equipment 14a may transmit the measured RSTD to the base station 11a. For example, the base station 11a may be an LMF, which refers to a server for estimating the position of the user equipment 14a, and may estimate the position of the user equipment 14a based on the received RSTD. According to embodiments, the base station 11a may provide a service (e.g., a location-based service, such as (e.g., navigation, search query for nearby services, gaming, etc.) to the user equipment 14a based on the estimated position of the user equipment 14a, and/or may transmit a signal to the user equipment 14a containing an indication of the estimated position. According to embodiments, the user equipment 14a may receive the signal containing the indication of the estimated position and may perform further operations based on the estimated position. The further operations may include providing the estimated position to an application executing on the user equipment 14a, the application using the estimated position to provide a location-based service (e.g., navigation, search query for nearby services, gaming, etc.) to the user equipment 14a. According to embodiments, provision of the location-based service (e.g., via the application, via the base station 11a, etc.) may include the user equipment 14a generating a first signal (e.g., based on data provided by the application), process the first signal to perform one or more among modulating, upconverting, filtering, amplifying and/or encrypting on the first signal, and transmit the processed first signal to an external device (e.g., to the base station 11a or via the base station 11a). Additionally or alternatively, the user equipment 14a may receive a second signal from the external device (e.g., from the base station 11a or via the base station 11a), process the second signal to perform one or more among demodulating, downconverting, filtering, amplifying and/or decrypting on the second signal, and perform a further operation(s) based on the processed second signal. For example, the further operation(s) may include one or more of providing the processed second signal to the application executing on the user equipment 14a, storing the processed second signal, sending a response signal to the external device (e.g., based on a processing result of the corresponding application), etc.

The user equipment 14a according to the inventive concepts may calculate a PDP based on PRSs received from base stations (for example, 11a, 12 of FIG. 1, and 13 of FIG. 12) and may perform a path search operation based on the calculated PDP, thereby detecting, as an FAP, a PDP index having a value of a first threshold PDP or more in the PDP. Because the user equipment 14a performs a path search operation for each PDP index, the user equipment 14a may detect a relatively accurate FAP, and thus, may measure a relatively accurate RSTD.

FIG. 3 is a flowchart illustrating a denoising operation of a user equipment, according to embodiments. FIG. 4 is a graph illustrating a denoising operation of a user equipment, according to embodiments.

Referring to FIGS. 2 and 3, a denoising operation 300 of the user equipment 14a may include a plurality of operations S310 and S320, which may be included in operation S220.

In operation S310, the user equipment 14a may calculate a PDP based on a PRS and may estimate a noise variance based on the calculated PDP. The noise variance may be estimated based on a mean power norm (MPN) representing the degree of magnifying the power of the PRS, a window representing a region for determining the noise of the PRS, and/or the magnitude of the PDP.

In operation S320, the user equipment 14a may calculate a corrected PDP by performing a denoising operation based on the noise variance estimated in operation S310. The denoising operation may refer to an operation of removing noise from a PDP.

In embodiments, the denoising operation may refer to an operation of subtracting, from the PDP calculated in operation S310, a specific value that is set based on the estimated noise variance. For example, referring further to FIG. 4, a specific value A may refer to a value that is set by multiplying a constant value by the square of the noise variance estimated in operation S310. A first graph 410 may be a graph illustrating the PDP calculated in operation S220, and here, the horizontal axis may represent a time delay t and the vertical axis may represent power (or signal strength, that is, a PDP value). A second graph 420 may be a graph illustrating a corrected PDP, and here, the horizontal axis may represent a time delay t and the vertical axis may represent power (or signal strength, that is, a PDP value). The user equipment 14a may perform a denoising operation to subtract the specific value A, which is set based on the noise variance, from the PDP (for example, the first graph 410) and may generate a corrected PDP (for example, the second graph 420) based on the denoising operation. When values obtained by subtracting the specific value A from the PDP are negative, all such values may be set as 0. The corrected PDP may refer to a PDP from which noise is removed.

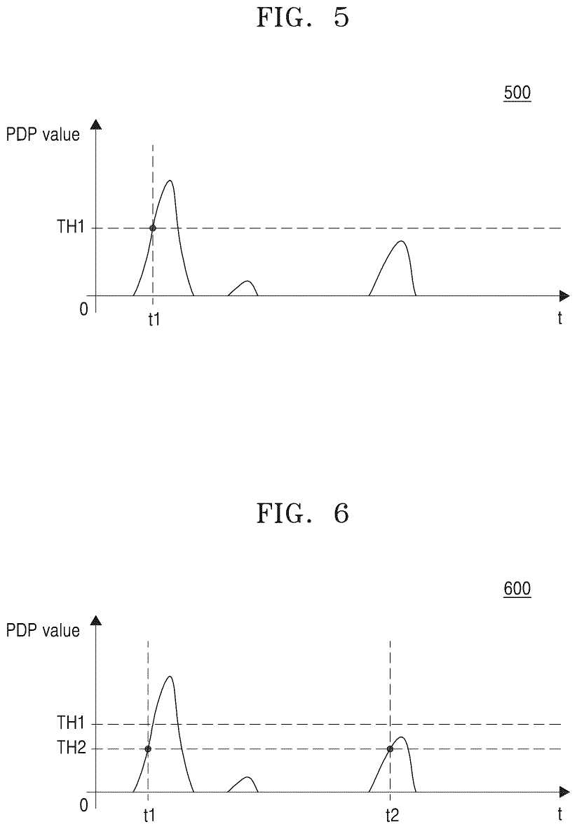

FIG. 5 is a graph illustrating a path search operation of a user equipment, according to embodiments.

Referring to FIGS. 2, 4, and 5, a third graph 500 for explaining a path search operation of the user equipment 14a may represent a corrected PDP, which refers to a noise-removed PDP, and may be the same as (or similar to) the second graph 420.

In embodiments, the user equipment 14a may detect at least one path including a first path by performing a path search operation based on a PDP, and the path search operation may include an operation of detecting, as the first path, a PDP index having a value of a first threshold PDP TH1 or more in the PDP. The first threshold PDP TH1 may be set as a product of the peak power of the PDP and a first ratio. For example, the first threshold PDP TH1 may be represented by Equation 1 shown below.

$$TH 1 = \frac{B 1}{128} \times {P}_{max} \qquad [ Equation 1 ]$$

B1 may be an integer of 0 to 128, and Pₘₐₓ may be peak power of the PDP. The first ratio may be equal to B1/128. The user equipment 14a may perform a path search operation in ascending order of PDP indices of the PDP, starting from the smallest PDP index, and may compare the first threshold PDP TH1 with the PDP indices, starting from the smallest PDP index. The user equipment 14a may detect, as the first path, a first PDP index t1 corresponding to the smallest PDP index among PDP indices having values of the first threshold PDP TH1 or more.

FIG. 6 is a graph illustrating a path search operation of a user equipment, according to embodiments.

Referring to FIGS. 2, 5, and 6, a fourth graph 600 for explaining a path search operation of the user equipment 14a may represent a corrected PDP, which refers to a noise-removed PDP, and may be the same as (or similar to) the second graph 420. Although the path search operation of the user equipment 14a is described below based on two threshold PDPs, the inventive concepts are not limited thereto. For example, the user equipment 14a may perform a path search operation based on two or more threshold PDPs.

In embodiments, the user equipment 14a may detect a multipath including at least one path by performing a path search operation based on a PDP, and the path search operation may include an operation of detecting the multipath including a first path, based on a plurality of threshold PDPs. For example, the plurality of threshold PDPs may include a first threshold PDP TH1 and a second threshold PDP TH2, and the user equipment 14a may select one of the first threshold PDP TH1 and/or the second threshold PDP TH2 based on a channel state.

For example, the channel state may be measured based on a value of noise for a received signal, and the user equipment 14a may select a threshold PDP having a relatively higher value from among the plurality of threshold PDPs as the noise for the received signal has a higher value. The first threshold PDP TH1 may be greater than the second threshold PDP TH2, and the user equipment 14a may select the first threshold PDP TH1 when the value of the noise for the received signal is greater than a threshold channel state, and may select the second threshold PDP TH2 when the value of the noise for the received signal is not greater than the threshold channel state. The threshold channel state may refer to a preset (or alternatively, given) specific value.

For example, when the second threshold PDP TH2 is selected from among the plurality of threshold PDPs, the path search operation may be an operation of detecting, as a multipath, PDP indices having values of the second threshold PDP TH2 or more in the PDP. The user equipment 14a may perform the path search operation in ascending order of PDP indices of the PDP, starting from the smallest PDP index, and may compare the second threshold PDP TH2 with the PDP indices, starting from the smallest PDP index. The user equipment 14a may detect, as the first path, a first PDP index t1 corresponding to the smallest PDP index among the PDP indices having values of the second threshold PDP TH2 or more. The next PDP index after the first PDP index t1 (having a value of the second threshold PDP TH2 or more) may be a second PDP index t2, and the user equipment 14a may detect the second PDP index t2 as a second path. The first threshold PDP TH1 may be set as a product of the peak power of the PDP and a first ratio, and the second threshold PDP TH2 may be set as a product of the peak power of the PDP and a second ratio. For example, the first threshold PDP TH1 may be represented by Equation 1 shown above, and the second threshold PDP TH2 may be represented by Equation 2 shown below.

$$TH 2 = \frac{B 2}{128} \times {P}_{max} \qquad [ Equation 2 ]$$

B2 may be an integer of 0 to 128, and Pₘₐₓ may be the peak power of the PDP. The second ratio may be equal to B2/128. According to embodiments, the first ratio has a value that is greater than that of the second ratio.

The user equipment 14a according to the inventive concepts may perform a path search operation based on at least two threshold PDPs and may detect a multipath. Therefore, an RSTD and a reference signal received path power (RSRPP) for each path may be calculated, and a relatively accurate position of the user equipment 14a may be estimated.

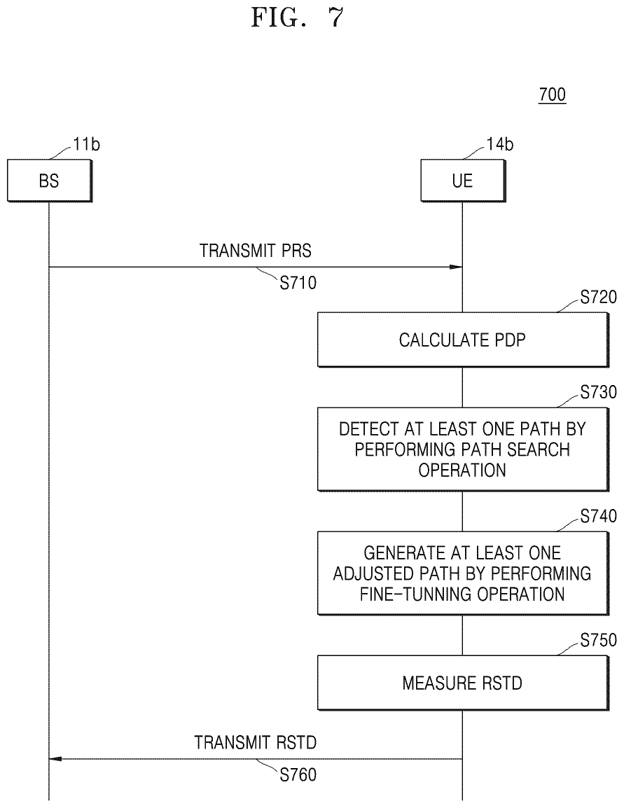

FIG. 7 is a flowchart illustrating an operation method of a user equipment, according to embodiments.

Referring to FIG. 7, an operation method 700 of a user equipment 14b may include a plurality of operations S710 to S760, and a base station 11b and the user equipment 14b may be examples of the base station 11a and the user equipment 14a of FIG. 2, respectively. Operations S710, S720, and S730 may be the same as (or similar to) operations S210, S220, and S230, respectively. Repeated descriptions given with reference to FIG. 2 are omitted.

In operation S740, the user equipment 14b may generate at least one adjusted path by performing a fine-tuning operation based on at least one path detected in operation S730. The fine-tuning operation may refer to an operation of compensating for an error occurring due to a sampling operation on a PDP.

In embodiments, the fine-tuning operation may include an operation of generating at least one adjusted path by using a weighted average based on the at least one path detected in operation S730.

For example, the fine-tuning operation may refer to an operation of generating at least one adjusted path by applying a weighted average to a piece of power of a PDP index (or the power that corresponds to the PDP index), which corresponds to the at least one path detected in operation S730, and pieces of power (e.g., powers) corresponding to two PDP indices that are adjacent to the PDP index corresponding to the at least one path detected in operation S730.

For example, the fine-tuning operation may refer to an operation of applying three pieces of PDP index power to Equation 3 shown below.

$$FP = {p}_{i} + \frac{PDP [ {p}_{i} + 1 ] - PDP [ {p}_{i} - 1 ]}{PDP [ {p}_{i} - 1 ] + PDP [ {p}_{i} ] + PDP [ {p}_{i} + 1 ]} \qquad [ Equation 3 ]$$

FP may represent a PDP index corresponding to a first adjusted path that is included in the at least one adjusted path, and pᵢ may refer to a PDP index corresponding to a first index out of the at least one path detected in operation S730. pᵢ−1 may refer to a PDP index corresponding to a small path (or smaller path), and the small path (or smaller path) may refer to a path corresponding to a PDP index having a smaller index value, out of two paths (or indices) adjacent to pᵢ. pᵢ+1 may refer to a PDP index corresponding to a large path (or larger path), and the large path (or larger path) may refer to a path corresponding to a PDP index having a larger index value, out of the two paths (or indices) adjacent to pᵢ. PDP[x] may refer to power of a PDP index corresponding to a path (or index) x.

In operation S750, the user equipment 14b may measure an RSTD based on the detected at least one adjusted path. For example, the user equipment 14b may generate at least one adjusted path including an FAP, based on PRSs received from the base station 11b and other base stations (for example, 12 and 13 of FIG. 1) adjacent to the base station 11b, and may measure an RSTD that refers to a difference in arrival time between the PRSs, based on the at least one adjusted path.

In operation S760, the user equipment 14b may transmit the measured RSTD to the base station 11b. For example, the base station 11b may be an LMF, which refers to a server for estimating the position of the user equipment 14b, and may estimate the position of the user equipment 14b based on the received RSTD.

The user equipment 14b according to the inventive concepts may calculate a PDP based on PRSs received from base stations (for example, 11b, 12 of FIG. 1, and 13 of FIG. 1) and may perform a path search operation based on the calculated PDP, thereby detecting, as an FAP, a PDP index having a value of a first threshold PDP or more in the PDP. Because the user equipment 14b performs a path search operation for each PDP index and performs a fine-tuning operation on the detected FAP, the user equipment 14b may detect the relatively accurate FAP. Therefore, the user equipment 14b may measure a relatively accurate RSTD.

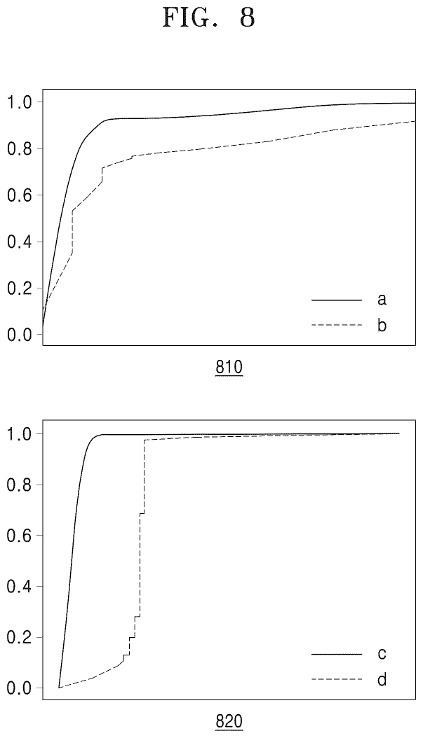

FIG. 8 is a graph illustrating an operation of a user equipment, according to embodiments.

Referring to FIGS. 2 and 8, a fifth graph 810 is a graph for comparing the degree of error (that is, a) of an FAP detected by performing a path search operation of the user equipment 14a according to embodiments with the degree of error (that is, b) of an FAP detected by performing a path search operation of a user equipment according to a comparison example. The vertical axis of the fifth graph 810 may represent a cumulative distribution function (CDF), and the horizontal axis of the fifth graph 810 may represent a measurement error. The path search operation of the user equipment according to the comparison example may refer to an operation of detecting an FAP by using a moving sum algorithm, and the moving sum algorithm may refer to an algorithm in which a moving sum referring to the sum of pieces of power is calculated, search is performed backward from a specific time point after a maximum-value (or highest-value) position, and an FAP is detected when the moving sum exceeds a specific reference value. The specific reference value may be set as a ratio with respect to the maximum value (or the highest value) of the moving sum. The accuracy of the FAP may relatively increase as the CDF corresponding to the measurement error gets closer to 1.0. Referring to the fifth graph 810, because the CDF with the degree of error (that is, a) of the FAP detected by performing the path search operation of the user equipment 14a according to embodiments is relatively closer to 1.0 than the CDF with the degree of error (that is, b) of the FAP detected by performing the path search operation of the user equipment according to the comparison example, it may be confirmed that the accuracy of the FAP detected by the user equipment 14a according to the inventive concepts is relatively higher than that of the comparison example.

Referring further to FIG. 7, a sixth graph 820 is a graph for comparing the degree of error (that is, c) of an FAP, which is detected by performing a path search operation and a fine-tuning operation by the user equipment 14b according to embodiments, with the degree of error (that is, d) of an FAP detected without performing a fine-tuning operation. The vertical axis of the sixth graph 820 may represent a CDF, and the horizontal axis of the sixth graph 820 may represent a measurement error. The accuracy of the FAP may relatively increase as the CDF corresponding to the measurement error gets closer to 1.0. Referring to the sixth graph 820, because the CDF in the case of performing the fine-tuning operation is relatively closer to 1.0 than the CDF in the case of not performing the fine-tuning operation, it may be confirmed that the accuracy of the FAP detected by the user equipment 14b according to the inventive concepts is relatively higher.

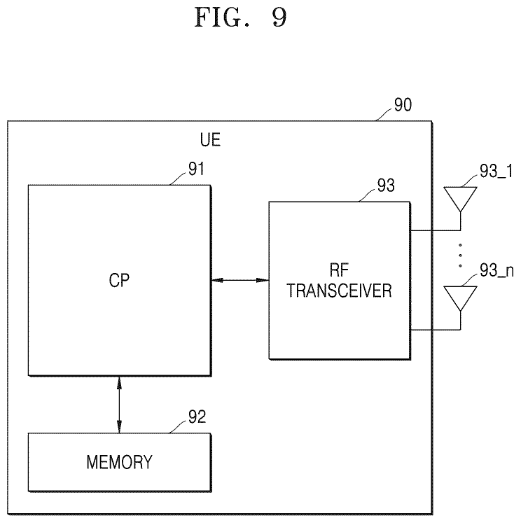

FIG. 9 is a block diagram illustrating a user equipment according to embodiments. An implementation example of a user equipment 90 of FIG. 9 may also be applied to the user equipment 14 of FIG. 1.

The user equipment 90 may include a communication processor 91, a memory 92, a radio-frequency (RF) transceiver 93, and/or a plurality of antennas 93_1 to 93_n. The RF transceiver 93 may receive, via the antennas 93_1 to 93_n, RF signals transmitted by the base station 11 of FIG. 1. The RF transceiver 93 may generate intermediate-frequency or baseband signals by down-converting the received RF signals. The RF transceiver 93 may up-convert intermediate-frequency or baseband signals, which are output from the communication processor 91, and may transmit the up-converted signals as RF signals via the antennas 93_1 to 93_n.

The communication processor 91 may generate data signals by filtering, decoding, and/or digitizing intermediate-frequency or baseband signals and may receive data signals from the RF transceiver 93. The communication processor 91 may encode, multiplex, and/or analogize the received data signals. The communication processor 91 may additionally process data signals and, to perform all control operations on the user equipment 90, may execute a program stored in the memory 92 and/or a process.

In embodiments, the communication processor 91 may receive a PRS from the base station 11 of FIG. 1, may calculate a PDP based on the PRS, and may detect, as an FAP, a PDP index having a value of a first threshold PDP or more in the PDP by performing a path search operation based on the calculated PDP. Because the path search operation is performed for each PDP index, the relatively accurate FAP may be detected. Therefore, a relatively accurate RSTD may be measured, and thus, an accurate position of the user equipment 90 may be estimated.

In embodiments, the communication processor 91 may perform a denoising operation, a path search operation, and/or a fine-tuning operation, which are described with reference to FIGS. 2 to 8.

The memory 92 may have any structure for storing data. For example, the memory 92 may include a volatile memory device, such as dynamic random-access memory (DRAM) or static random-access memory (SRAM), or may include a nonvolatile memory device, such as flash memory or resistive random-access memory (RRAM).

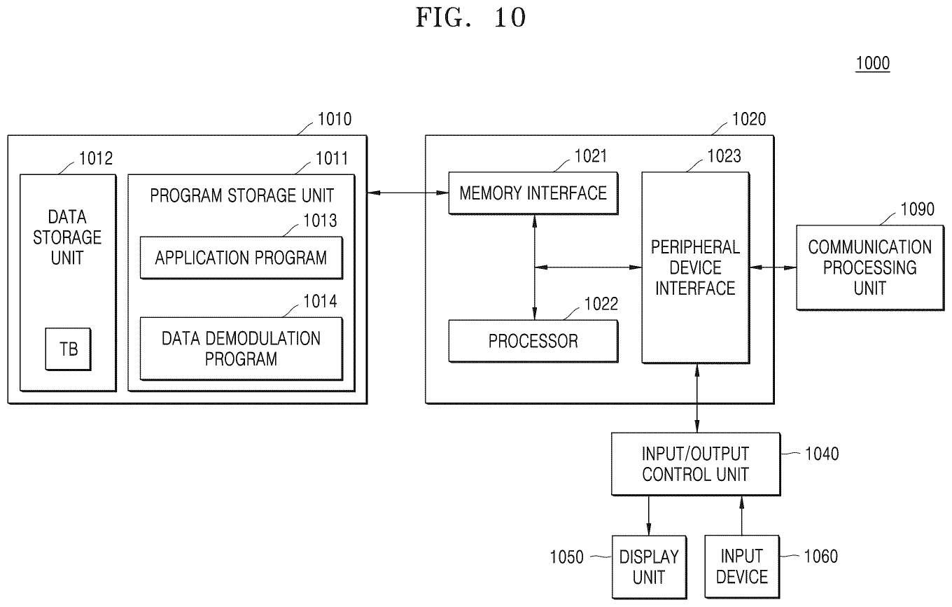

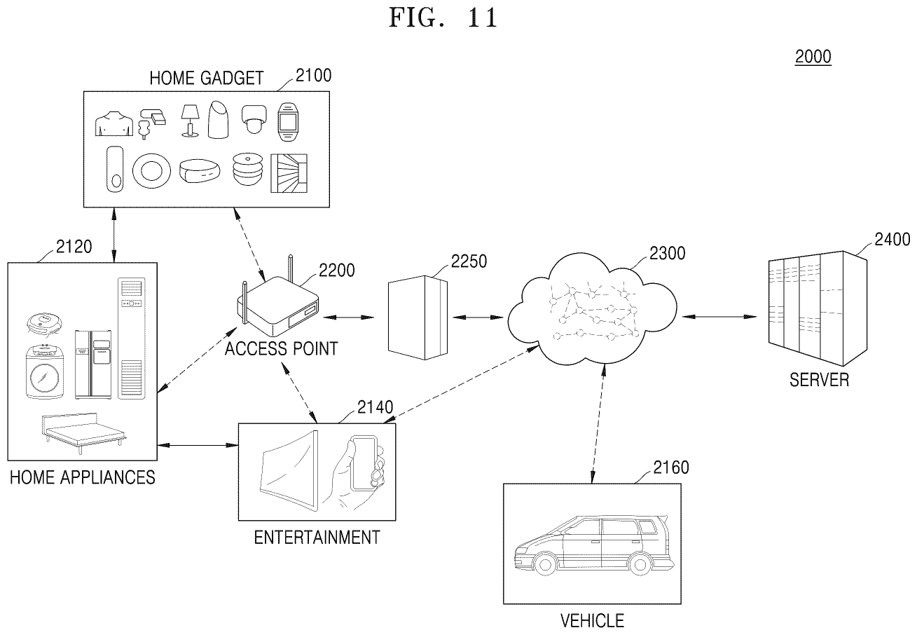

FIG. 10 is a block diagram illustrating an electronic device according to embodiments. An electronic device 1000 may include, but is not limited to, a user equipment according to embodiments. For example, the electronic device 1000 may include a device for communicating with an external network (for example, the base stations 11, 12, and 13 of FIG. 1 or an external server) or may include an autonomous driving vehicle, a robot, or the like.

Referring to FIG. 10, the electronic device 1000 may include a memory 1010, a processor unit 1020, an input/output control unit 1040, a display unit 1050, an input device 1060, and/or a communication processing unit 1090. Here, the memory 1010 may be provided in a plural number. Descriptions of the respective components may be made as follows.

The memory 1010 may include a program storage unit 1011 storing a program for controlling operations of the electronic device 1000 and/or a data storage unit 1012 storing data generated during the execution of the program. The data storage unit 1012 may store data required (or otherwise, used) for operations of an application program 1013 and/or a data demodulation program 1014, or may store data generated from the operations of the application program 1013 and/or the data demodulation program 1014.

The program storage unit 1011 may include the application program 1013 and/or the data demodulation program 1014. Here, the program in the program storage unit 1011 is a set of instructions and may be referred to as an instruction set. The application program 1013 may include pieces of program code for performing various applications that operate on the electronic device 1000. That is, the application program 1013 may include pieces of code (or commands) regarding various applications driven by a processor 1022.

The electronic device 1000 may include the communication processing unit 1090 configured to perform a communication function for speech communication and data communication. A peripheral device interface 1023 may control connections between the input/output control unit 1040, the communication processing unit 1090, the processor 1022, and a memory interface 1021. By using at least one software program, the processor 1022 controls a plurality of base stations to provide a service corresponding to the software program. Here, by executing at least one program stored in the memory 1010, the processor 1022 may provide a service corresponding to the program.

In embodiments, the processor 1022 may receive a PRS from the base station 11 of FIG. 1, may calculate a PDP based on the PRS, and may detect, as an FAP, a PDP index having a value of a first threshold PDP or more in the PDP by performing a path search operation based on the calculated PDP. Because the path search operation is performed for each PDP index, the relatively accurate FAP may be detected. Therefore, a relatively accurate RSTD may be measured, and thus, an accurate position of the electronic device 1000 may be estimated. In embodiments, the processor 1022 may perform a denoising operation, a path search operation, and/or a fine-tuning operation, which are described with reference to FIGS. 2 to 8.

The input/output control unit 1040 may provide an interface between input/output devices, such as the display unit 1050 and/or the input device 1060, and the peripheral device interface 1023. The display unit 1050 displays state information, input characters, moving pictures, still pictures, and the like. For example, the display unit 1050 may display application information regarding applications driven by the processor 1022.

The input device 1060 may provide input data generated through selection by the electronic device 1000 to the processor unit 1020 via the input/output control unit 1040. Here, the input device 1060 may include a keypad including at least one hardware button, a touchpad for sensing touch information, and the like. For example, the input device 1060 may provide the touch information, such as a touch, a touch motion, or a touch release, which is sensed by the touchpad, to the processor 1022 via the input/output control unit 1040.

FIG. 11 is a conceptual diagram illustrating an Internet-of-Things (IoT) network system to which embodiments are applied.

Referring to FIG. 11, an IoT network system 2000 may include a plurality of IoT devices (that is, 2100, 2120, 2140, and/or 2160), an access point 2200, a gateway 2250, a wireless network 2300, and/or a server 2400. IoT may refer to a network between things using wired/wireless communication.

Each of the IoT devices (that is, 2100, 2120, 2140, and/or 2160) may form a group, depending on characteristics of each IoT device. For example, the IoT devices may be grouped into a home gadget group 2100, a home appliance/furniture group 2120, an entertainment group 2140, a vehicle group 2160, or the like. A plurality of IoT devices (that is, 2100, 2120, and/or 2140) may be connected to a communication network or another IoT device via the access point 2200. The access point 2200 may be embedded in one IoT device. The gateway 2250 may change a protocol such that the access point 2200 is connected to an external wireless network. The IoT devices (that is, 2100, 2120, and/or 2140) may be connected to the external communication network via the gateway 2250. The wireless network 2300 may include the Internet and/or a public network. The plurality of IoT devices (that is, 2100, 2120, 2140, and/or 2160) may be connected, via the wireless network 2300, to the server 2400 providing a certain service, and a user may use the service via at least one of the plurality of IoT devices (that is, 2100, 2120, 2140, and/or 2160).

In embodiments, each of the plurality of IoT devices (that is, 2100, 2120, 2140, and 2160) may receive a PRS from the base station 11 of FIG. 1, may calculate a PDP based on the PRS, and may detect, as an FAP, a PDP index having a value of a first threshold PDP or more in the PDP by performing a path search operation based on the calculated PDP. Because the path search operation is performed for each PDP index, the relatively accurate FAP may be detected. Therefore, a relatively accurate RSTD may be measured, and thus, accurate positions of the plurality of IoT devices (that is, 2100, 2120, 2140, and/or 2160) may be estimated. In embodiments, each of the IoT devices (that is, 2100, 2120, 2140, and/or 2160) may perform a denoising operation, a path search operation, and/or a fine-tuning operation, which are described with reference to FIGS. 2 to 8.

Conventional devices and methods for determining a position of a UE involve determining a time difference of arrival with respect to times at which DL-PRSs arrive at the UE. However, in order to determine an accurate position using this technique, the DL-PRSs should be received at the UE via a line-of-sight (LoS) path. In scenarios in which the DL-PRSs are received via a multipath, for example, due to scattering, diffraction, reflection, etc., the conventional devices and methods are unable to determining the UE position with sufficient accuracy.

However, according to embodiments, improved devices and methods are provided for determining a position of a UE. For example, the improved devices and methods may involve calculating a power delay profile (PDP) based on a PRS, and detecting a first arrival path (FAP) (e.g., a LoS path) by performing a path search operation on the PDP. Accordingly, the improved devices and methods are able to measure a more accurate reference signal time difference (RSTD) based on the detected FAP even in scenarios involving multipath. Therefore, the improved devices and methods overcome the deficiencies of the conventional devices and methods to at least improve the accuracy of the determined position of the UE.

According to embodiments, operations described herein as being performed by the wireless communication system 100, each among base stations 11, 12, and/or 13, the user equipment 14, the user equipment 14a, the base station 11a, the user equipment 14b, the base station 11b, the user equipment 90, the communication processor 91, the RF transceiver 93, the electronic device 1000, the processor unit 1020, the input/output control unit 1040, the communication processing unit 1090, the peripheral device interface 1023, the processor 1022, the memory interface 1021, the IoT network system 2000, each among the plurality of IoT devices 2100, 2120, 2140, and/or 2160, the access point 2200, the gateway 2250, and/or the server 2400 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 92, the memory 1010, etc.). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

While the inventive concepts have been particularly shown and described with reference to embodiments thereof, it will be understood that various changes in form and details may be made therein without departing from the spirit and scope of the following claims.

What is claimed is:

1. An operation method of a user equipment configured to perform wireless communication with a base station, the operation method comprising:
receiving a positioning reference signal (PRS) from the base station;
calculating a power delay profile (PDP) based on the PRS;
detecting at least one path by performing a path search operation based on the PDP, the at least one path including a first path, the path search operation including detecting a first PDP index as the first path, the first PDP index having a value corresponding to a first power of a first threshold PDP or more, and the first threshold PDP being based on a peak power of the PDP; and
measuring a reference signal time difference (RSTD) based on the first path.

2. The operation method of claim 1, wherein
the first threshold PDP is a product of the peak power and a first ratio; and
the first ratio is a real number of 1 or less.

3. The operation method of claim 1, wherein
the at least one path includes the first path and a second path;
the path search operation includes detecting a second PDP index as the second path, the second PDP index having a value corresponding to a second power of the first threshold PDP or more; and
the value of the second PDP index is greater than the value of the first PDP index.

4. The operation method of claim 1, wherein
the path search operation includes selecting the first threshold PDP from among a plurality of threshold PDPs based on a channel state of the user equipment; and
the channel state is measured based on a value of noise for a signal received by the user equipment.

5. The operation method of claim 1, wherein
the first threshold PDP is one of a second threshold PDP or a third threshold PDP;
the path search operation includes,
designating a second PDP index as a first candidate for the first path, the second PDP index having a value corresponding a second power of the second threshold PDP or more,
designating a third PDP index as a second candidate for the first path, the third PDP index having a value corresponding to a third power of the third threshold PDP or more, and
detecting one among the first candidate and the second candidate to be the first path; and
the second threshold PDP has a value that is greater than that of the third threshold PDP.

6. The operation method of claim 1, wherein the path search operation comprises detecting the first path in ascending order of PDP indices of the PDP starting from a smallest PDP index among the PDP indices.

7. The operation method of claim 1, further comprising:
generating a first adjusted path by performing a fine-tuning operation based on the first path,
wherein the measuring of the RSTD based on the first path includes measuring the RSTD based on the first adjusted path.

8. The operation method of claim 7, wherein the generating of the first adjusted path includes generating the first adjusted path by using a weighted average based on the first path.

9. The operation method of claim 8, wherein the using of the weighted average includes applying the weighted average to the first power and powers respectively corresponding to two PDP indices adjacent to the first PDP index.

10. The operation method of claim 1, wherein
the calculating of the PDP comprises:
estimating a noise variance based on the PRS, and
calculating a corrected PDP by performing a denoising operation on the PDP based on the noise variance, the denoising operation including removing noise; and
the detecting of the at least one path includes detecting the at least one path by performing the path search operation based on the corrected PDP.

11. An operation method of a user equipment configured to perform wireless communication with a base station, the operation method comprising:
receiving a positioning reference signal (PRS) from the base station;
calculating a corrected power delay profile (PDP) by removing noise based on the PRS;
detecting a first PDP index as a first path among at least one path, the first PDP index having a value corresponding to a first power of a first threshold PDP or more, the first threshold PDP being a product of peak power of the PDP and a first ratio, and the first ratio being a real number of 1 or less;
generating at least one adjusted path by performing a fine-tuning operation based on the at least one path; and
measuring a reference signal time difference (RSTD) based on the at least one adjusted path.

12. The operation method of claim 11, wherein
the at least one path includes the first path and a second path;
the method further comprises detecting a second PDP index as the second path, the second PDP index having a value corresponding to a second power of a second threshold PDP or more;
the second threshold PDP is a product of the peak power and a second ratio, the second ratio being a real number of 1 or less; and
the first ratio has a value that is greater than that of the second ratio.

13. The operation method of claim 11, wherein the detecting of the first PDP index comprises detecting the at least one path by comparing the first threshold PDP with PDP indices of the PDP in ascending order of the PDP indices starting from a smallest PDP index among the PDP indices.

14. The operation method of claim 11, wherein the fine-tuning operation comprises generating a first adjusted path by applying a weighted average to the first power and powers respectively corresponding to two PDP indices adjacent to the first PDP index.

15. The operation method of claim 11, wherein the calculating of the corrected PDP comprises:
estimating a noise variance based on the PRS; and
calculating the corrected PDP by removing the noise based on the noise variance.

16. A user equipment configured to perform wireless communication with a base station, the user equipment comprising:
a plurality of antennas; and
processing circuitry configured to,
receive a positioning reference signal (PRS) from the base station,
calculate a power delay profile (PDP) based on the PRS,
detect at least one path by performing a path search operation based on the PDP, the at least one path including a first path, the path search operation including detecting a first PDP index as the first path, the first PDP index having a value corresponding to a first power of a first threshold PDP or more, and the first threshold PDP being based on a peak power of the PDP, and
measure a reference signal time difference (RSTD) based on the first path.

17. The user equipment of claim 16, wherein
the at least one path includes the first path and a second path;
the path search operation includes detecting a second PDP index as the second path, the second PDP index having a value corresponding to a second power of the first threshold PDP or more; and
the value of the second PDP index is greater than the value of the first PDP index.

18. The user equipment of claim 16, wherein
the path search operation includes selecting the first threshold PDP from among a plurality of threshold PDPs based on a channel state of the user equipment; and
the channel state is measured based on a value of noise for a signal received by the user equipment.

19. The user equipment of claim 16, wherein the processing circuitry is configured to perform the path search operation in ascending order of PDP indices of the PDP starting from a smallest PDP index among the PDP indices.

20. The user equipment of claim 16, wherein the processing circuitry is configured to:
generate a first adjusted path by performing a fine-tuning operation using a weighted average based on the first path; and
measure the RSTD based on the first adjusted path.
